(19) United States
(12) Patent Application Publication
(10) Pub. No.: US 2020/0276469 A1
(43) Pub. Date: Sep. 3, 2020

(54) Exercise Apparatus

(71) Applicants: Jerrod Daniel Anderson, Allen, TX (US); Clinton Robert Anderson, Tulsa, OK (US)

(72) Inventors: Jerrod Daniel Anderson, Allen, TX (US); Clinton Robert Anderson, Tulsa, OK (US)

(21) Appl. No.: 16/647,016

(22) PCT Filed: Sep. 12, 2018
(86) PCT No.: PCT/IB2018/056955

§ 371 Date: Mar. 12, 2020

Related U.S. Application Data
(60) Provisional application No. 62/674,361, filed on May 21, 2018.
(60) Provisional application No. 62/557,437, filed on Sep. 12, 2017.

(51) Int. Cl. A63B 21/00

(52) U.S. Cl. CPC A63B 21/4035; B25G 3/20; A63B 21/4047

(57) ABSTRACT

In one embodiment, an apparatus may include one or more of a receiver, wherein the receiver is substantially cylindrical on a first end and substantially circular on a second end, and a handle including a lower portion, wherein the handle is substantially oblong, wherein the lower portion and the second end are detachably attached to one another via one or more securing objects positioned in a first aperture disposed on the second end, wherein the receiver is configured to be detachably attached to a substantially cylindrical element via the one or more securing objects positioned in a second aperture disposed on the first end. In another embodiment, an apparatus may include one or more of a central portion, an end portion located on each end of the central portion, and a substantially circular handle disposed within each of the substantially semicircular portions, wherein the handles are at opposing angles to one another, wherein the central portion includes at least one eyelet configured to receive one or more elements.

### TECHNICAL FIELD

This application generally relates to weightlifting equipment and more specifically relates to apparatus that allow users to effectively perform resistance training. These pieces of equipment were designed to provide a better, more efficient, and more effective workout than what other pieces of equipment offer providing a full body or specific specialized isolated workout to the user depending on the way they are utilized and setup. Any major muscle group can be strengthened with the use of these devices and they may be used by general fitness users, bodybuilders, strength athletes, powerlifters, and/or any and all competitive sport athletes.

### BACKGROUND

In the market today, there exists may pieces of training and weightlifting equipment. There has always been a distinct separation between the weight room and the playing field. It is advisable that athletes are trained according to the demands of their particular sport rather than for pure strength. The idea is ‘functional’ strength relative to the sport the athlete is competing in. The movement patterns and requirements of an offensive lineman, specifically, require a different training regime and different pieces of equipment than a baseball or basketball player. With the current examples, it is desirable to close the gap between the weight room and the playing field providing strength training equipment that mimic and provide more specific movement patterns related to the athletes' sport.

### SUMMARY

An apparatus may include one or more of a receiver, wherein the receiver is substantially cylindrical on a first end and substantially circular on a second end, and a handle including a lower portion, wherein the handle is substantially oblong, wherein the lower portion and the second end are detachably attached to one another via one or more securing objects positioned in a first aperture disposed on the second end, wherein the receiver is configured to be detachably attached to a substantially cylindrical element via the one or more securing objects positioned in a second aperture disposed on the first end.

In another example embodiment, an apparatus may include a receiver, wherein the receiver is substantially cylindrical on a first end and substantially circular on a second end, and a handle including a lower portion, wherein the handle is substantially oblong, wherein the lower portion and the second end are detachably attached to one another via one or more securing objects positioned in a first aperture disposed on a bottom portion of the second end, wherein the receiver is configured to be detachably attached to a substantially cylindrical element via the one or more securing objects positioned in a second aperture disposed on an upper portion of the first end.

In another embodiment, an apparatus may include one or more of a central portion, an end portion located on each end of the central portion, and a substantially circular handle disposed within each of the substantially semicircular portions, wherein the handles are at opposing angles to one another, wherein the central portion includes at least one eyelet configured to receive one or more elements.

### BRIEF DESCRIPTION OF THE DRAWINGS

The novel features believed to be characteristic of this apparatus are set forth with particularity in the appended claims. The apparatus itself, however, both as to its organization and method of operation, together with further objects and advantages thereof, may best be understood by reference to the following description taken in connection with the accompanying drawings in which:

FIG. 1 illustrates a view of an example of a first apparatus.

FIG. 2 illustrates side view of an example of the first apparatus.

FIG. 3 illustrates top view of an example of the first apparatus.

FIG. 4 illustrates the first apparatus as another example implementation.

FIG. 5 is a diagram of the different types of handles that may be connected to the receiver of the first apparatus.

FIG. 6 illustrates various embodiments of a second apparatus of the current device.

FIG. 7 illustrates an example of the second apparatus.

FIG. 8. illustrates further examples of the second apparatus.

FIG. 9 illustrates various embodiments of the sled mine, another implementation of the current device.

FIG. 10 illustrates a close-up view of the current apparatus.

FIG. 11 illustrates alternate embodiments of the current apparatus.

FIG. 12 illustrates yet further alternate embodiments of the current apparatus.

FIG. 13 illustrates another embodiment of the current apparatus including a ball handle attachment.

FIG. 14 illustrates another embodiment of the current apparatus including a universal link.

FIG. 15 illustrates another embodiment of the current apparatus including a revolving handle attachment.

FIG. 16 illustrates another embodiment of the current application including the joining of two devices together.

FIG. 17 illustrates another embodiment of the current application including another example of the joining of two devices.

FIG. 18 illustrates another embodiment of the current application including coaching (pressure) handles.

FIG. 19 illustrates a Computer Aided Design (CAD) diagram of the second apparatus.

FIG. 20 illustrates a CAD diagram of the first apparatus.

FIG. 21 illustrates a CAD diagram of another embodiment of the current apparatus.

### DETAILED DESCRIPTION

In the current weightlifting environment, numerous weight rooms contain multiple “Jammer” machines that take up massive amounts of space and can be extremely expensive to obtain. These machines have two handles that the athlete grabs onto and in a standing athletic position will thrust the handles forward with arms straight out. This machine is on a fixed track and not dynamic in movement. In one embodiment, the current device is designed to fit onto the end of a barbell that provides a more robust workout for the user due to the dynamic and unrestrained nature of the barbell in its pivot (landmine, sledmine, or against the wall/corner). This device setup is more cost effective and allows the weight room to accommodate and train more athletes than the typical jammer setup. For example, football offensive line trainers may utilize the device to simulate a football athlete striking an opponent with their hands inside a defender's shoulders and the puts the users elbows more in line with the body in a better biomechanical position for power transfer. Different training equipment, such as the previously mentioned “Jammer” machine and other similar devices do not position the athlete in a manner that is conducive to football athletes. The attachment pieces can be removed from the receiver allowing any style of handle to be utilized so any competitive athlete or user can replicate the motion they desire for their sport.

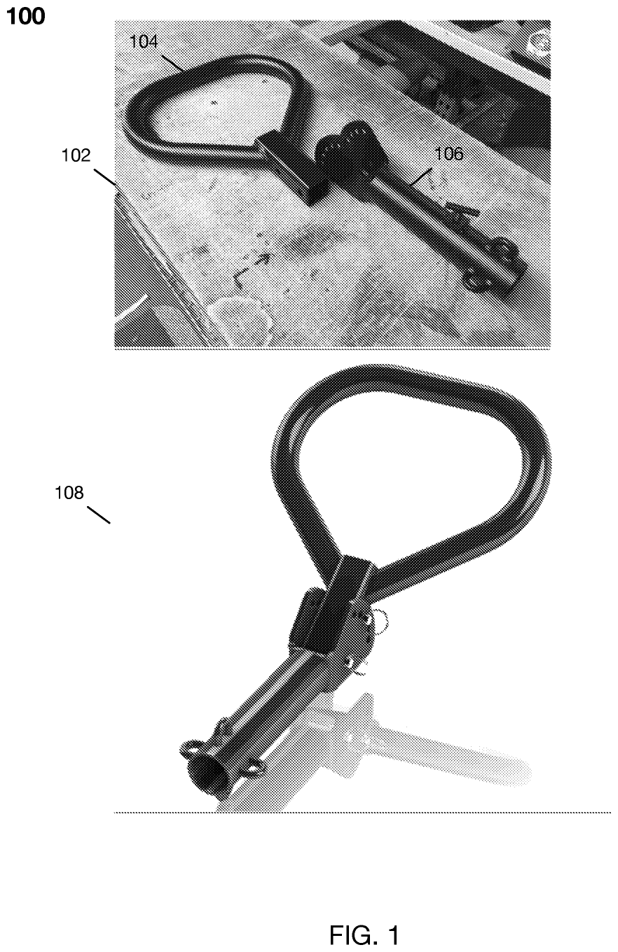

FIG. 1 illustrates a view of an example of a first apparatus 100. A photo of the apparatus 102 shows a handle 104 and a receiver 106. The handle 104 (which is detachably attached to the receiver 106) puts a user's elbows and hands in an optimal position (around 45 degrees with palms up and thumbs out) for various movements (including a triple extension squat and press) similar to movements displayed by various individuals such as, offensive and defensive linemen on a football or other field. A number of other functional movements are possible on the current apparatus, only limited by the imagination and creativity of the athlete and the handle used. Functional movements include but are not limited to: front squats, single and double shoulder press, abdominal rotations, one arm back rows, deadlifts, jump squats, upright rows, and high pulls. A diagram 108 shows the handle and receiver connected, in another example of the current apparatus.

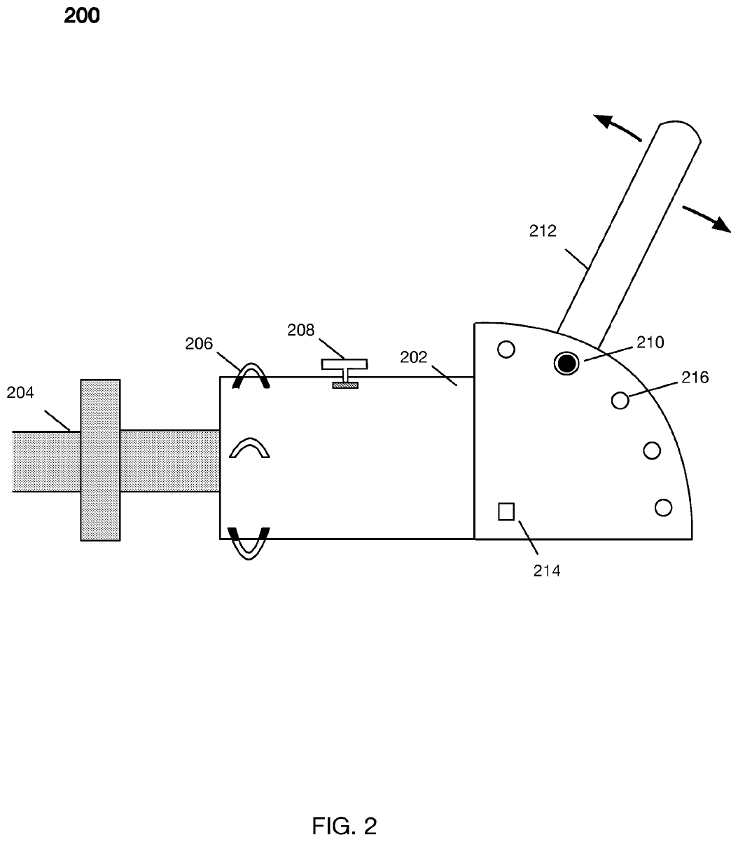

FIG. 2 illustrates side view of an example of the first apparatus. The current apparatus 202 (henceforth referred to as the receiver) is connected to a bar 204 of various weights (for example a 45 lb. weightlifting bar). The current apparatus may also be attached to a sled or other type of cylindrical projection with the same dimensions of a 45 lb. bar sleeve that can receive the device.

The receiver 202 slides onto one end of a bar or other cylindrical projection 204 and is attached in various ways, such as via a strap that is fastened to the receiver and the bar 204, or via a hinge clamp such as a barbell or spring clamp or attached by a clamp with a strap that tightens or loosens the clamp, or via a screw clamp 208 that tightens onto the bar sleeve or other cylindrical projection 204. The screw clamp mechanism 208 clamps down on the bar 204 by assembling a button-head bolt from the inside of the tube and then welding a handle onto it 208 preventing the device from moving on the bar or pole or ever coming out of the sleeve. The screw clamp 208 may also be a standard screw that simply tightens onto the barbell or cylindrical projection 204.

At least one hook 206 may be present on the receiver 202, such that it is possible to attach a strap or the like and apply additional force to the exercise from other angles.

A handle 212 is slid onto the receiver 202 and connected to the receiver via to connections 214 and 210. The connections 214/210 may be pins or screw clamps or the like. The lower connection 214 is attached to the end of the handle 212, and the upper connection 210 is set to a desired angle of use. There exists a plurality of holes 216 such that the angle of connection of the handle 212 to the receiver 202 may be set to the user's preferred angle.

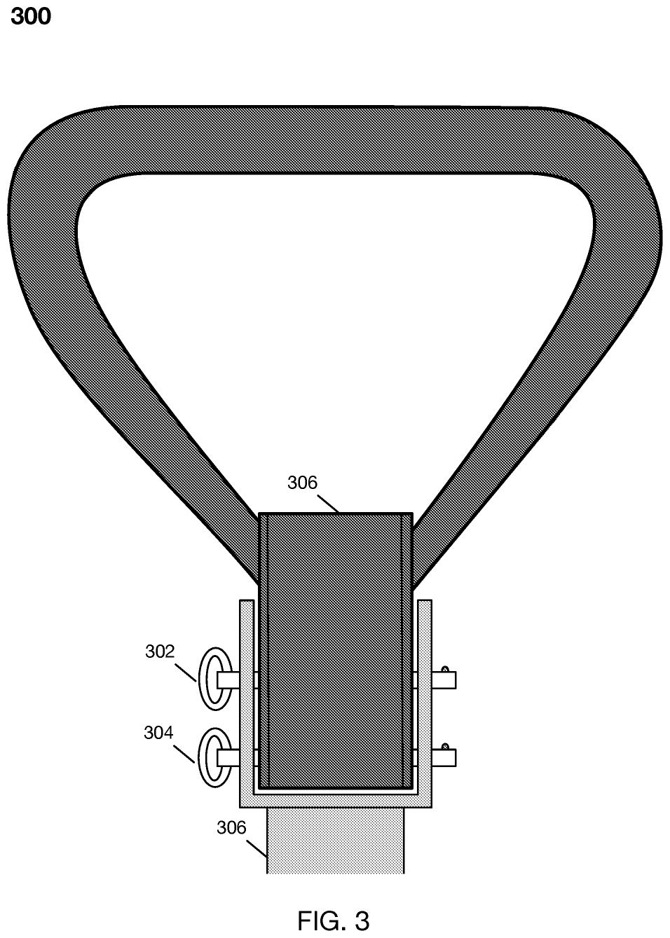

FIG. 3 illustrates top view of an example of the first apparatus. The handle 306 is attached to the receiver 306 via two pins 302/304. The pins may be a screw type, or any other pin type. The first pin 302 allows for the angle of the handle to be set, and the bottom pin 304 hinges the base of the handle 304.

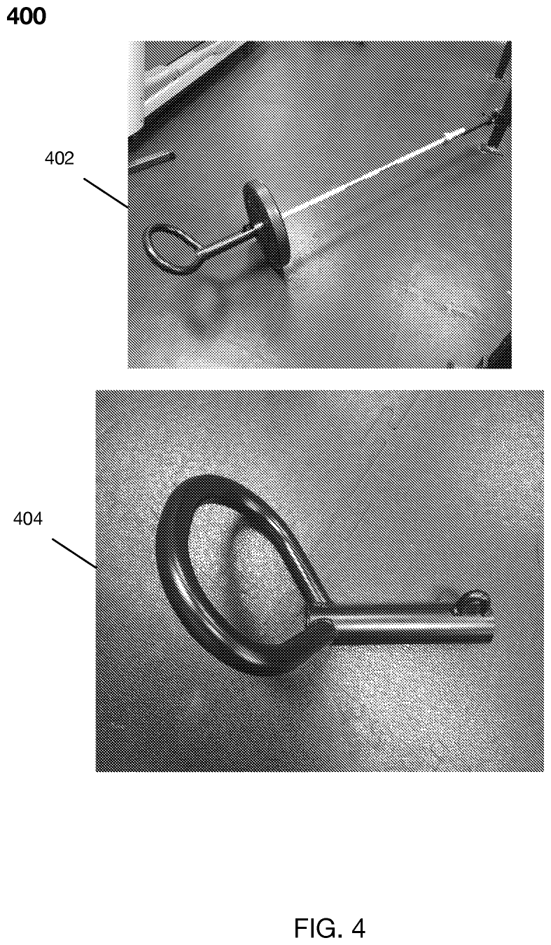

FIG. 4 illustrates the first apparatus as another example implementation 400. The first photo 402 shows the apparatus connected to a 45 lb. weightlifting bar, and the bottom picture shows the apparatus alone. This embodiment discloses the handle and receiver as one piece and is unable to be separated.

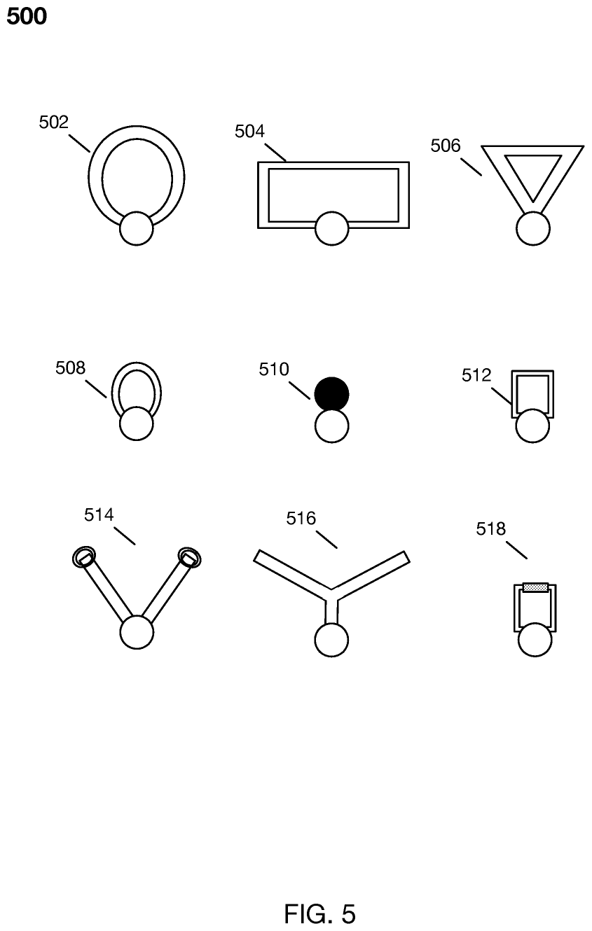

FIG. 5 is a diagram 500 of the different types of handles that may be connected to the receiver of the first apparatus 306. The receiver 202 that slides on the bar 204 will be able to accept many different handles. Handle variations include but are not limited to: a large oblong circle 502, a rectangle 504, a triangle 506, a small oblong circle 508, a solid ball 510, a square 512, two small circles with approx. 45 degree handles inside 514, a “T” bar for back rows 516, individual handles 518, a squat attachment with padded shoulders (not depicted), a “T” Bar with small handle projections for neutral grip back rows (not depicted).

The handles may be permanent or removable. The handles have square or cylindrical tubing that slides onto the square or cylindrical tubing of the receiver. The square or cylindrical tubing on the receiver will be adjustable similar to a moving joint allowing the handle to be straight out, straight up and anywhere in between held stationary with the use of a pin or screw clamp.

A second apparatus is disclosed. The second apparatus is a device designed to put an individual (such as an offensive or defensive line athlete) in a core dominated position by simulating athletic movements that recruit stabilizer and core muscles that are utilized when receiving pressure from an opponent (such as an offensive lineman in a pass protection or run blocking scenario). A user's elbows are tucked in close to the midline of the body and the hands externally rotated away from the midline, gripping the handles positioned around 45 degrees inside the wheel with the palms substantially up and thumbs substantially out.

In one embodiment, the inside handles of the second apparatus has the capability of rotating 360 degrees within the circular casing with the use of a ball bearing system installed around the outside edges of circular handles. The interior handles can also rotate on a fixed bolt, such as a shoulder bolt, installed on the top or bottom of the circular handles.

In another embodiment, the second apparatus has a number of loop connections, such as two, four to eight connections on the top, bottom, right and/or left for connecting weight and/or bands to give the user added resistance. The user activates his or her core (and other muscles and areas) in order to keep the object in the correct position. Various objects, such as ropes/bands, can be attached onto the wheel via the loop connections to give resistance in various positions (such as, in front of, behind or beside the individual). Numerous connections and functional movements are possible with the second apparatus, limited only by the creativity and imagination of the user and/or coach including but not limited to: the coach pushing and pulling on the device, the coach applying pressure to a pad attachment, the coach twisting the wheel left or right, the coach hitting a detachable pad, adding weight with bands on the device, pulling on attached bands on the left or right side of the device, pulling bands attached on the side of the device behind the user, and adding weight to an attachment on the front of the device that receives weights.

An added functionality of the second apparatus is the ability to place attachments in the center of the device. These attachments include: another “eyelet” for attaching more bands/ropes/weight, a half dome pad that allows a coach to apply pressure to the user holding the device, a cylindrical projection to receive weight, and the ability to attach the device to a projection that is attached to a sled for pushing. These attachments can be placed in a number of ways, such as screwed into a permanent thread located in the middle of the device between the handles, attached by clamp or locking mechanism along the outside metal, with square tubing inserted into a sleeve on the Second apparatus held tightly by 2 pins, etc.

Another embodiment of the current device is designed for the user to get a more sport specific core workout while taking repetitions in his or her stance. Many core or abdominal exercises have the athlete on the floor, however, in competition the athlete is standing, moving, running, etc. With band and or rope attachments the user can strengthen and stabilize his or her core while recreating movements used on the playing field for a more real life application to strength training. The device is mobile in nature and can be used during practice or in the weight room. In order to engrain the necessary movement patterns of offensive line play (pass setting, striking opponents, run blocking, etc.) the athlete must practice over and over. The constant hitting of athletes in pads can be detrimental to their bodies. This device will help many offensive line athletes strengthen their core and develop the necessary movement patterns for offensive line play without the beating and stress on their joints.

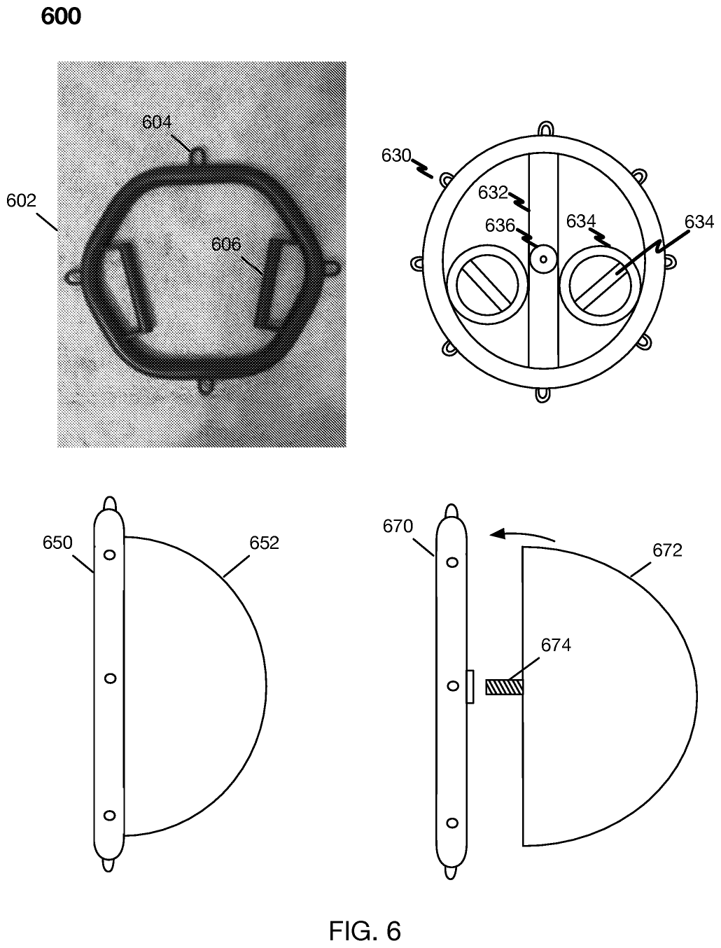

FIG. 6 illustrates various embodiments of a second apparatus of the current device 600. One example is depicted in the first diagram 602. The wheel 602 is present with two handles 606 wherein a user is able to grab the device at an approximate 45 degree angle. Additionally, 4 loop connections 604 exist to attach other elements to provide additional resistance.

Another embodiment of the current apparatus 630 is depicted with some embodiments of the current device. This wheel 630 builds upon the existing device 602, by adding additional capabilities. A bar exists 632 wherein a hole is added to the middle of the wheel 636, which is used to connect the wheel to other elements, as disclosed herein. Additionally, two circular elements are added to the wheel 634. Each of the two circular elements include a bar 634, wherein the user is able to grab the bars inside the wheel. In another embodiment, the bars 634 inside the circular elements are able to be rotated in a circular fashion around the wheel 634 via the addition of ball bearings in the wheels 634.

In another embodiment of the current device, a third example 650 is depicted with the second apparatus 650 attached to a pad 652. The pad is connected to the wheel and may be a permanent connection or removeable. The functionality of the pad is further disclosed here.

In another embodiment of the current device, a fourth example 670 is depicted where in the second apparatus 670 is shown separate from the pad 762. A screw 674 on the pad is used to screw the pad into the second apparatus 670.

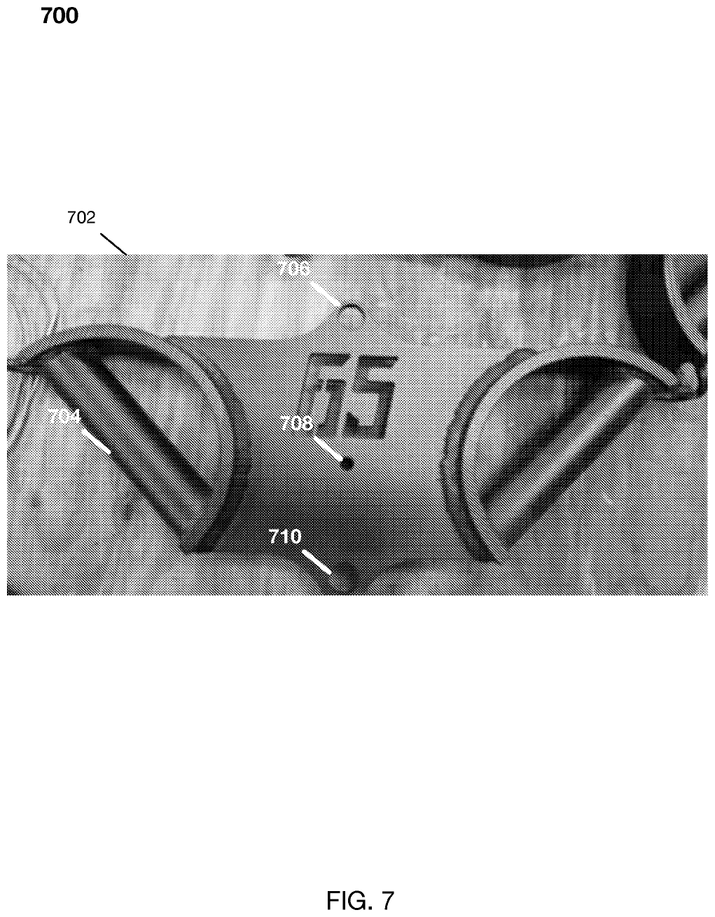

FIG. 7 illustrates an example of the second apparatus 700. Holes in the apparatus 706 and 710 are used for the attachment of ropes and/or bands to provide resistance to the user holding the device. Hole 710 may provide for additional weight to be attached for more pull on the device in a downward direction and hold 706 for more resistance in an upward direction.

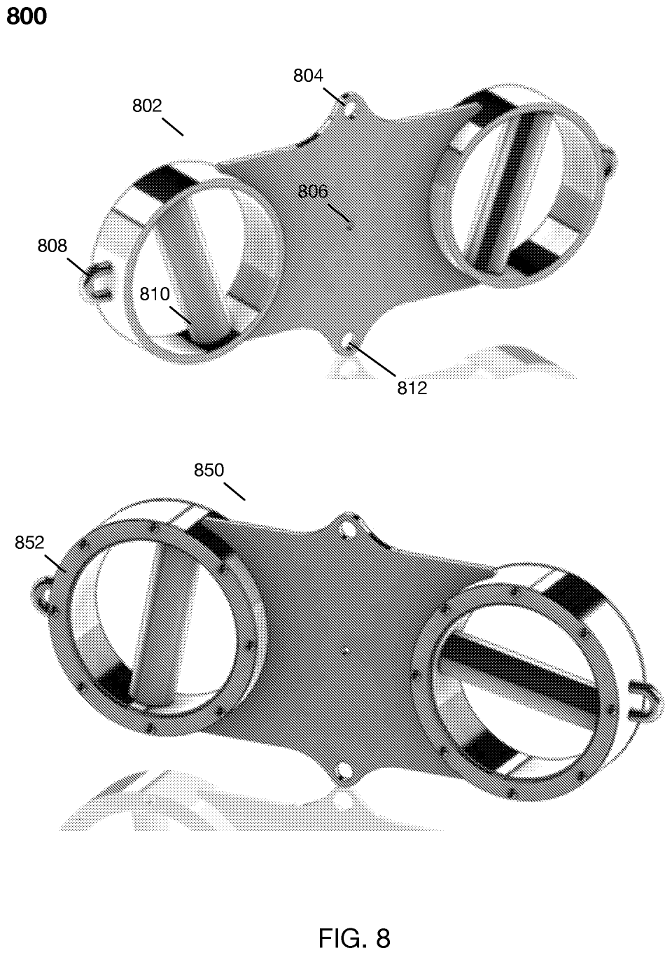

FIG. 8 illustrates further examples of the second apparatus 800. There are two views depicted in the FIGS. 802 and 850. In this embodiment, the handles 810 may be rotated in a circle 852 to provide additional flexibility in the exercises. Outside hooks 808 are used for band and/or rope attachments to provide right and left outside resistance, as well as holes 804/812, which may provide outside resistance in an upward or downward direction. The user grabs the handles 810 while another person grabs the ropes and/or bands attached to the device via 804, 808, 812 to provide additional resistance in any direction. That person pulls resistance on the device forcing the user to brace his or her core thereby strengthening and stabilizing muscles required for the particular sport (i.e. football). Specific to football offensive linesmen, the additional person can attach two bands to either side of the apparatus 808 a pull resistance behind the athlete that is in a pass protection stance. The athlete will resist the pressures felt by the pulling of the bands. This helps the athlete react better to action scenarios (i.e. a pass protection) by moving his or her feet with the various pressures felt. In another embodiment, a metal tubing (i.e. 2 inch by 2 inch) may be connected in the center 806. The same attachments may be attached in all apparatus, making the current apparatus' universal in nature.

In current configurations, landmine devices have only allowed connections to weightlifting racks or connections by sliding the devices post into the center hole of stacked weights. In another embodiment of the current apparatus, the apparatus is designed to be able to attach to any vertical or horizontal post such that the user is able to get an effective workout anywhere. The apparatus is more mobile in nature. A user is able to attach the apparatus to a sled that is pushed, inserting a barbell into the apparatus effectively turning that sled into a full body workout anywhere and any place.

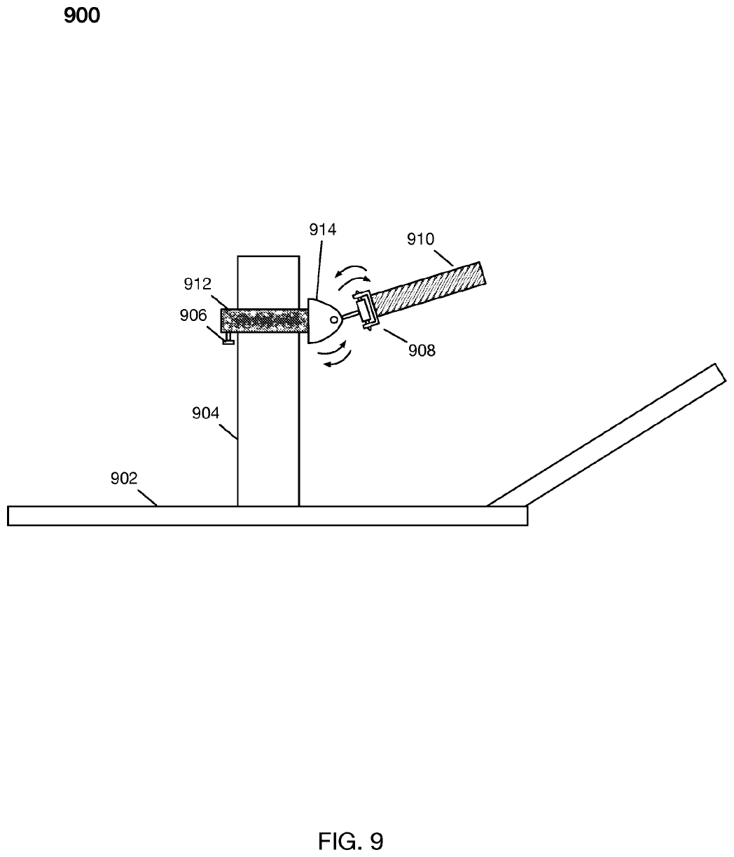

FIG. 9 illustrates various embodiments of the sled mine 900, another implementation of the current device. This implementation contains a sleeve 912 that slides over any vertical or horizontal post 904, converting that post into a device that is able to receive a bar or tube (e.g., a 45 lb. weightlifting bar, or a post 904 connected to a landmine 902). Two hinge component 908 and 914 are present on the current apparatus allowing for full motion of a handle 910. Once connected, the apparatus rotates and moves fully within a 180 degree manner only limited by range of motion of the implement itself. A locking mechanism 906 is present to lock the apparatus at a particular location on the bar 904. When the locking mechanism 906, such as a screw clamp is not clamped down, the handle 910 is able to rotate a full 360 degree on the vertical or horizontal post 904 allowing weightlifting exercises such as but not limited to pressing the bar, squatting with the bar, rotating with the bar, curling the bar, or other similar exercises.

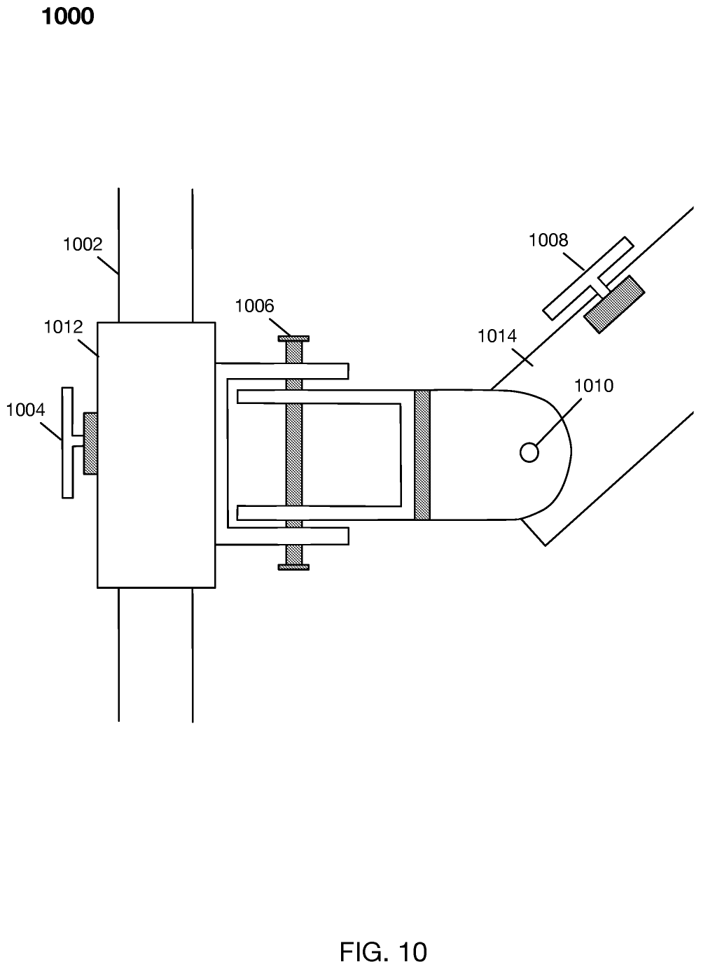

FIG. 10 illustrates a close-up view of the current apparatus 1000. The bar/post, or cylindrical projection 1002 may be any vertical or horizontally positioned bar/post, or cylindrical projection that accepts standard weight plates (around 1.90 in circumference) such as a sled with vertical posts and/or a standard weight holder (commonly referred to as a “tree”) with horizontal posts. The current apparatus 1012 is slid onto the bar or post 1002 and may be tightened at any point on the bar 1002 by a locking mechanism 1004. This locking mechanism 1004 is tightened wherein a steel bar inside the locking mechanism is pushed onto the bar 1002 to tighten the current apparatus 1012.

In one implementation, there exists two hinges 1006 and 1010 on the current apparatus. One or both hinges may be removable such that a pin exists that may be removed (not depicted) or locked into place or may be immovable such as depicted in 1006 and 1010.

In yet another implementation, a locking pin 1008 may be present to lock bars that are slipped into the handle 1014.

In another embodiment, the current apparatus contains a sleeve (1012) which can attach to a post 1002 by the use of a hinge clamp such as a barbell or spring clamp or attached by a clamp with a strap that tightens or loosens the clamp.

The current apparatus turns any vertical or horizontal post 904 into a cylindrical sleeve that receives a tube or bar, such as a weightlifting bar, and rotates in 180 degrees in all movement planes 908 to perform weightlifting exercise such as the ones mentioned above. The advantage to this device is the mobility and manner in which it installs onto any sled that has a vertical or horizontal cylindrical projection or post that a user already owns. Users are able to use their existing exercise sled with a vertical plate loading post to do ‘landmine’ exercises.

In another embodiment, the locking mechanism consists of a button head screw that is installed from the inside of the receiver tube with a handle welded that will clamp the bar or tube rendering it immovable from the receiver tube during use 1204.

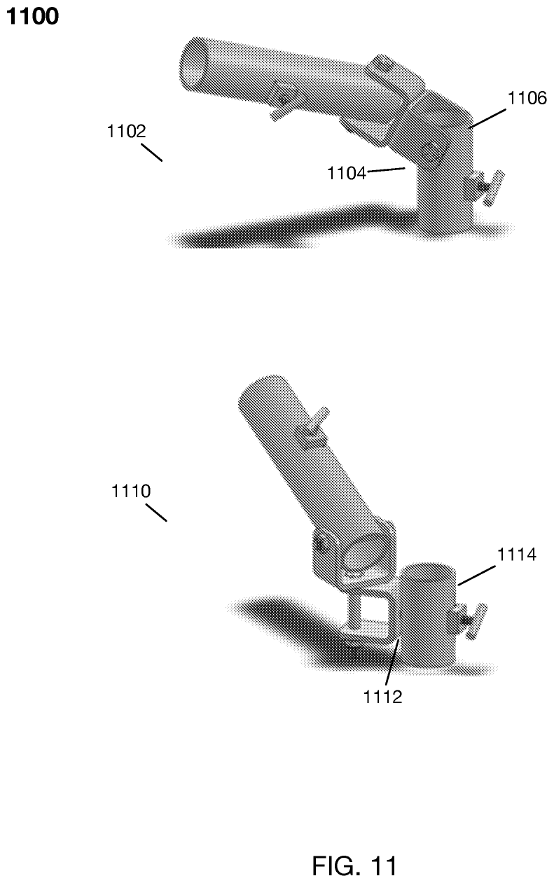

FIG. 11 illustrates alternate embodiments of the current apparatus 1100. The top diagram 1102 shows one method of connection where the lower bar 1106 is hinged to the top portion 1104 at the upper portion of the bar. The lower diagram 1110 shows another method of connection where the lower bar 1114 is hinged to the middle portion 1112 of the bar.

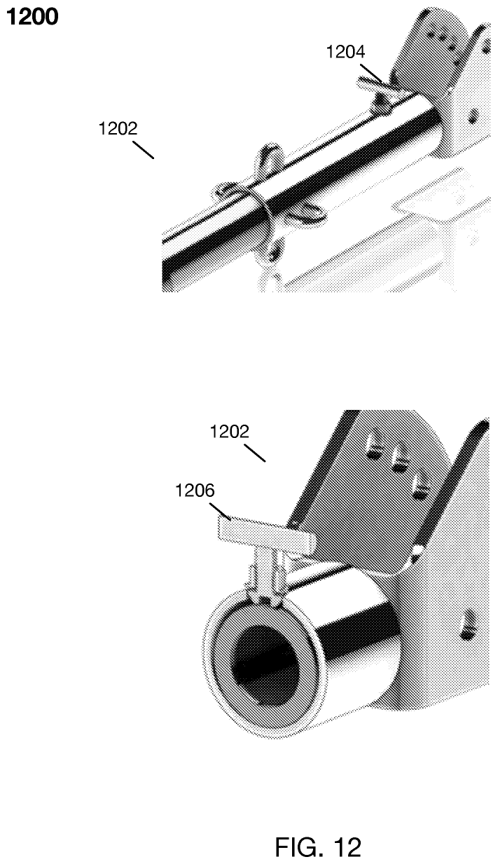

FIG. 12 illustrates yet further alternate embodiments of the current apparatus 1200. The top FIG. 1202 depicts the current apparatus with a locking mechanism 1204 at the rear of the sleeve. The lower FIG. 1202 depicts the apparatus sliced to show further detail. As can be seen in the diagram, the locking mechanism 1206 is designed such that the mechanism may be turned, but not removed from the hole by the enlarging of the locking mechanism at the portion of the locking mechanism opposite the turning handle.

The locking mechanism (208/1004/1008/1204/1206) clamps down on the bar by assembling a button-head bolt from the inside of the tube and then welding a handle onto it preventing the device from moving on the bar or pole or ever coming out of the sleeve. This locking mechanism is novel due to the fact the screw cannot be removed from the device due to the button head bolt being assembled from the inside of the tube, as can be seen at 1206. This device is installed by screwing it into the tube and assembling or welding a bolt, such as a button-head bolt, or any other flat piece of material to the screw from the inside of the tube. The bolt or other flat device is larger than the entrance of the screw which doesn't allow the screw to completely be removed but can be clamped down on a tube such as a weightlifting bar.

In another embodiment, the locking mechanism 1204/1206 is the same locking mechanism in the first apparatus 208. The advantage to this is the fact that a user cannot lose the locking clamp because it is unable to be removed from the mechanism and will hold any cylindrical projection that it is clamped onto.

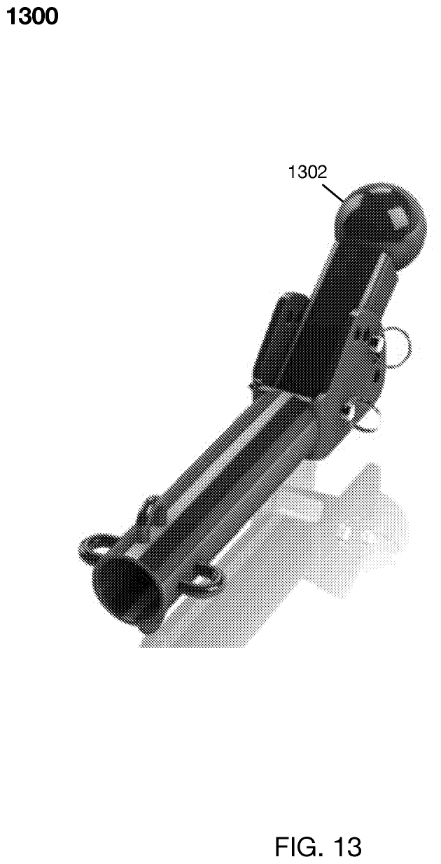

FIG. 13 illustrates another embodiment of the current apparatus 1300 including a ball handle attachment 1300. This attachment allows the user to gain grip strength by gripping the ball 1302 with a single hand and pressing, pulling, holding the attachment in various ways on the current apparatus. The ball 1302 can mimic an Olympic shot putter by holding the ball near the neck area and thrusting in an upwards and outwards motion. This attachment can also be attached to the second apparatus' attachment slot used on the ground to hold up an athlete attempting an unstable push up. The ball handle will also have a smaller handle that is attached between the metal 2×2 tubing and ball. This allows the user an additional grip to hold onto and execute weightlifting movements.

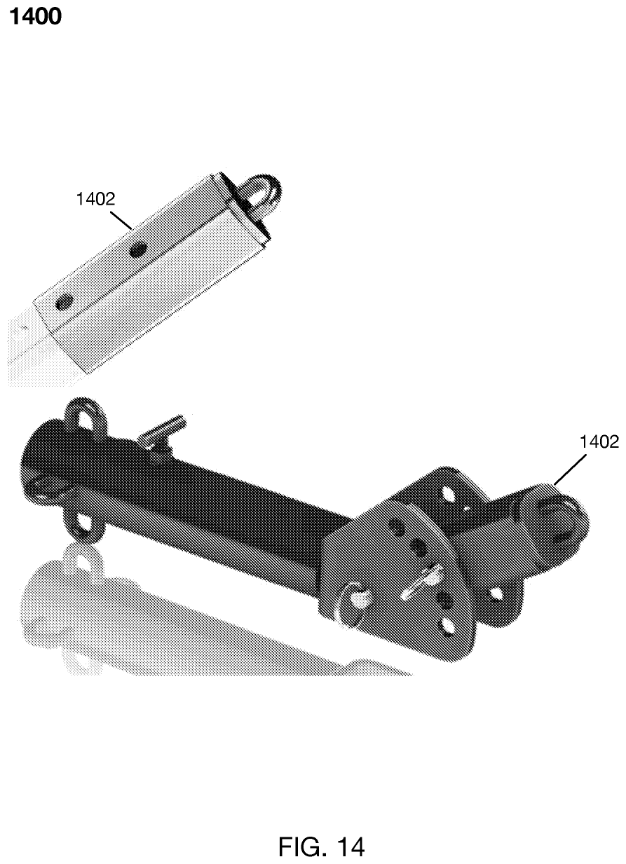

FIG. 14 illustrates another embodiment of the current apparatus 1400 including a universal link 1402. This attachment may be used with the first and/or second apparatus' and allows the user to attach any device he or she wants or already owns. A carabiner or any clip can attach to the eyelet and attach a chain or other device to connect another attachment. The universal link 1402 may attach to the center of the second apparatus allowing the device to be used on any weight lifting cable machine or the user can attach additional bands and or ropes to the eyelet for additional resistance.

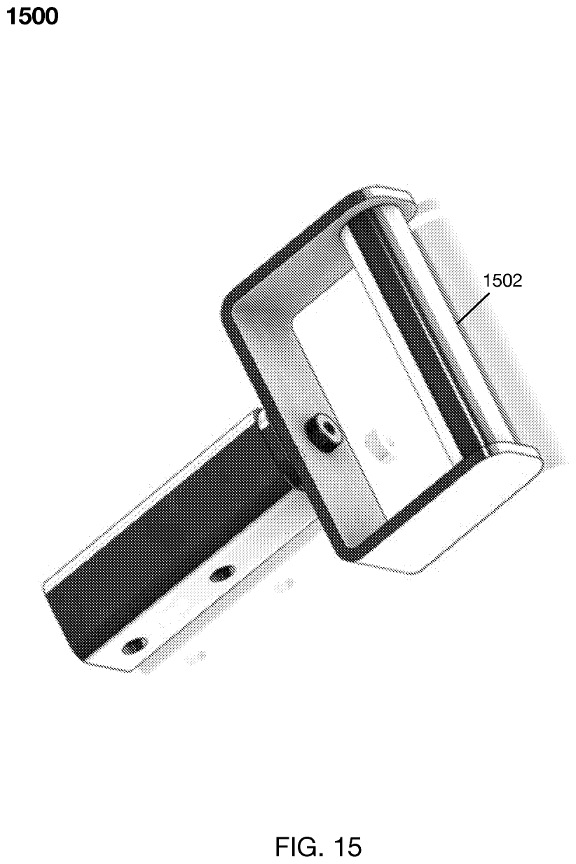

FIG. 15 illustrates another embodiment of the current apparatus 1500 including a revolving handle attachment 1500—This attachment piece allows the user to perform a multitude of single arm exercises on the first apparatus. The piece will attach with two pins 302 and 304 (for a static position) or one pin 304 (for full range of motion). The handle 1502 spins 360 degrees for full movement through the exercise. The attachment can also fit into the second apparatus center attachment slot for a coaching handle allowing the user holding the second apparatus to feel various pressures applied by a second person holding the handle 1500.

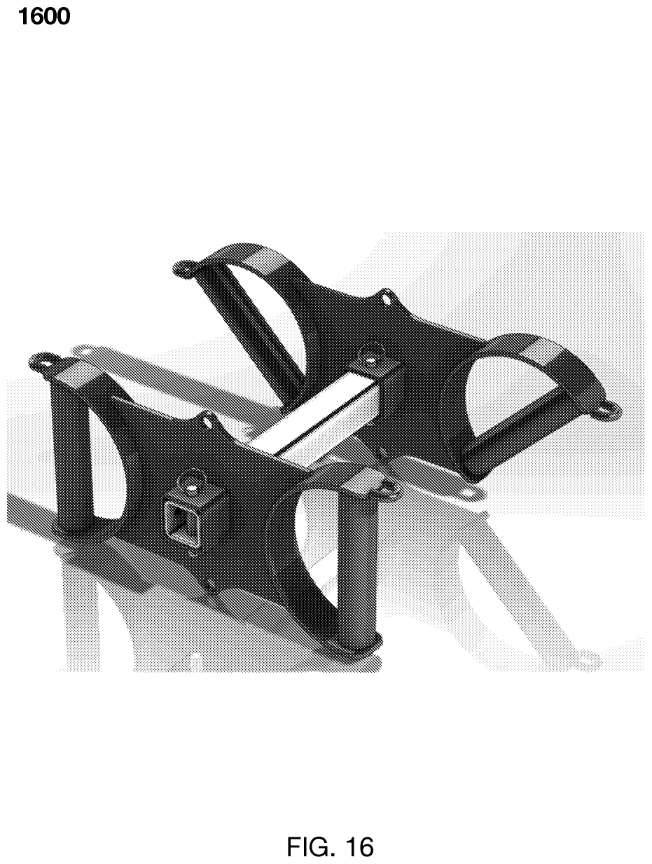

FIG. 16 illustrates another embodiment of the current application 1600 including the joining of two devices together. This demonstrates the ability to connect two second apparatus' together through the center attachment 806 with a square tubing (among other tubing connections) that allows two people to face each other and apply pressures to one another strengthening hands, forearms, arm, core, among other muscle groups. This also shows that the orientation of the second apparatus' handles can be vertical rather than at 45 degrees.

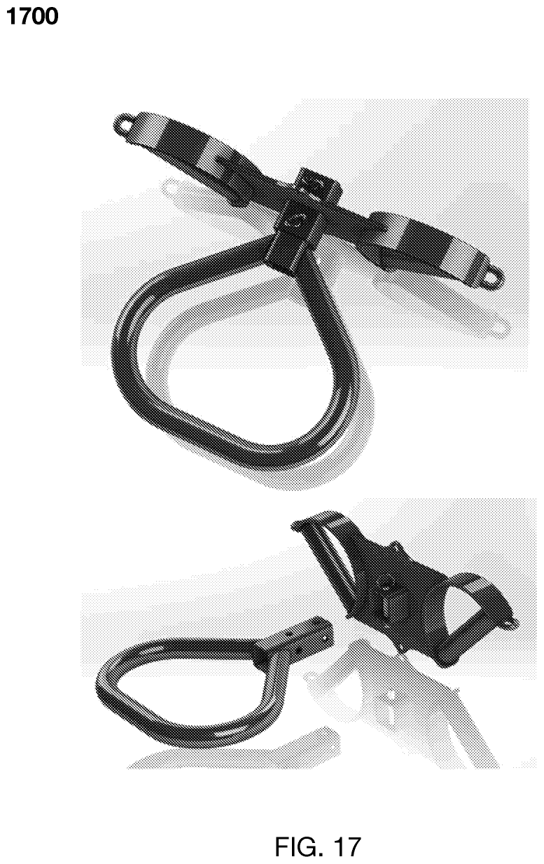

FIG. 17 illustrates another embodiment of the current application 1700 including another example of the joining of two devices. This demonstrates how any first apparatus attachment will also fit into the second apparatus center piece. All attachments will have two holes drilled on every side of the base allowing the attachment to be interested with any orientation.

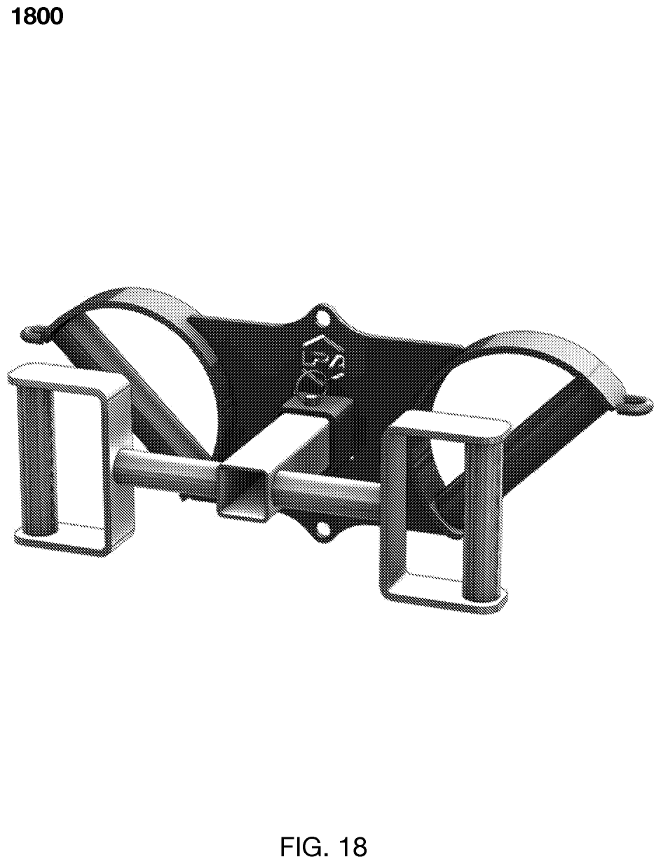

FIG. 18 illustrates another embodiment of the current application 1800 including coaching (pressure) handles. This attachment piece can be installed on the second apparatus allowing the user to feel various pressure applications from a second user pushing, pulling, turning, etc. the vertical handles. This builds stability and strength in the user's hands, arms, legs, core, etc. for functional training related more specifically to the athlete's sport, namely football (Offensive Line). These handles can also be used as an attachment piece to the first apparatus allowing the user to perform a neutral grip overhead shoulder press.

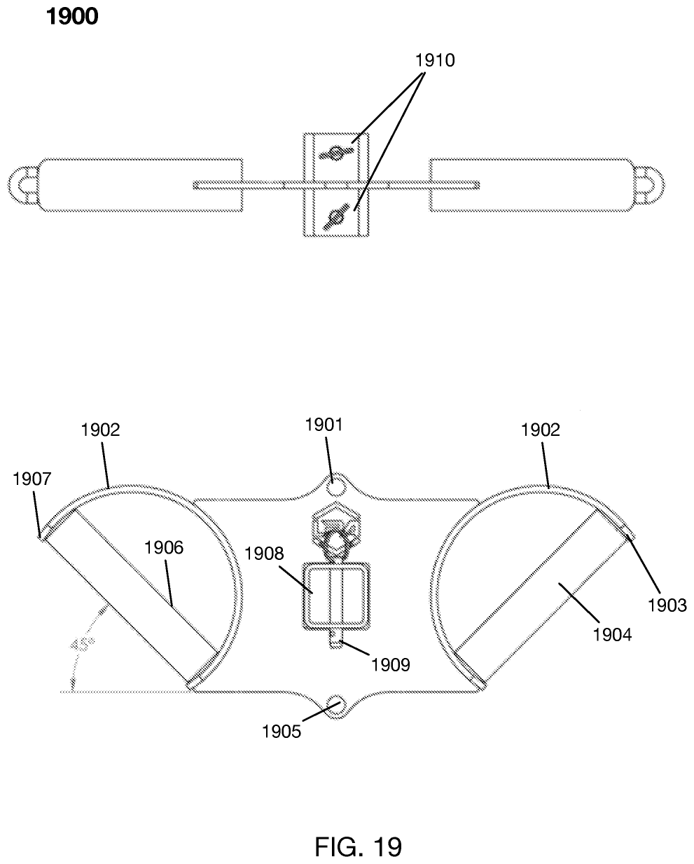

FIG. 19 illustrates a CAD diagram of the second apparatus 1900. Holes 1901, 1903, 1905 and 1907 allow the user to attach ropes, bands, chains, pulley systems, etc. to the device to create anti-rotational pressure on the athlete holding the device with handles 1904 and 1906. The apparatus 1900 can be held in an upright or downright position for varying handle (1904 and 1906) orientations to achieve different stresses on the user's muscles and joint orientations. 1902 Half circle insets can be fixed in one position and/or have the capability of rotating in any position 360 degrees with the use of ball bearings within an enclosed frame or with the use of a pinned system to fixate the handles in the desired orientation. Center attachment receiver 1908 allows the user to attach an additional apparatus to the device 1900 by sliding the attachments post through the center and attaching with pins such as 1910. This setup allows the user to attach any attachment from the first apparatus FIG. 1, 2, 3 into the center of apparatus in FIG. 19. Handles 1904 and 1906 can be knurled or smooth.

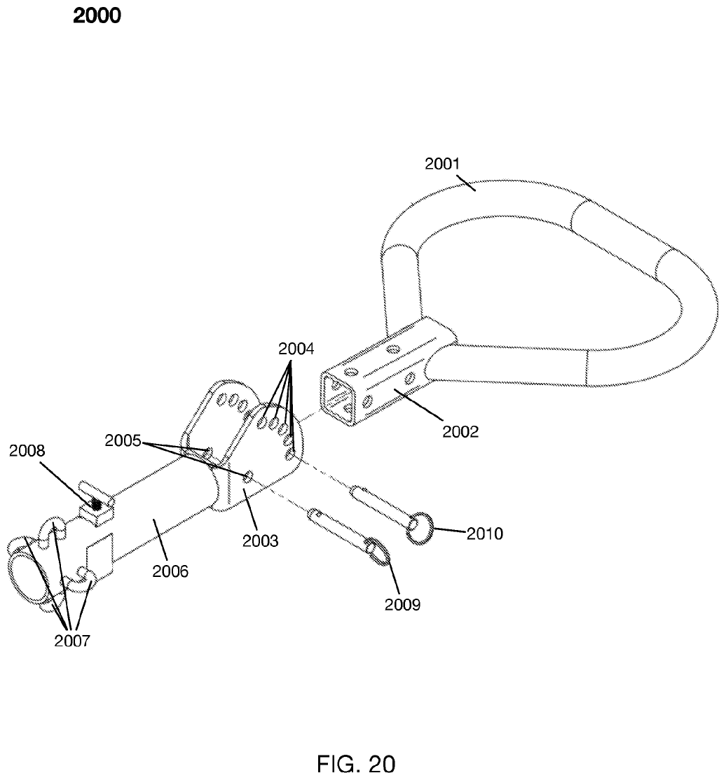

FIG. 20 illustrates a CAD diagram of the first apparatus 1900. An attachment such as 2001 is attached to 2006 by the use of a pins 2009. 2002 has holes drilled on all sides for different orientations for the user. 2002 is slid into 2003 and pin 2009 slides into holes 2005 to hold the attachment on the device. With this setup the attachment such as 2001 can move freely all the way up or all the way down. If the user pins 2010 into one of the holes on 2004 the attachment such as 2001 can be in a fixed manner and not move. Cylinder 2006 is slid onto a bar such as a weightlifting bar that allows the user free range of motion to use the apparatus 2000 in any manner they choose. Apparatus 2000 can be held onto said bar by use of a screw clamp such as 2008, by a strap system that attaches to one or more eyelets 2007 and to said bar, or by the use of a hinge clamp that tightens around said bar. Eyelets 2007 can be used to attach bands, ropes, chains, pulley system to the apparatus 2000. Handle 2001 allows the users hands, wrists, arms, and elbows to be positioned in line with the user's body for a more natural range of motion during the lift. The bottom portion of 2001 handles are approximately 45 degrees but can be varying degrees. The Top portion of 2001 is straight allowing the user to hold the handle in front of the body. This attachment 2001 can be smooth or knurled grip.

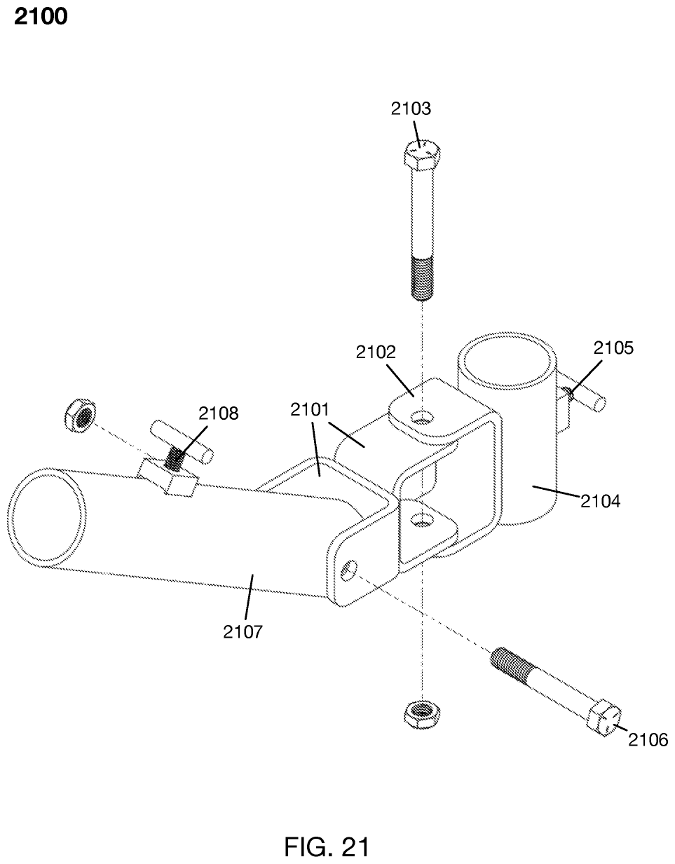

FIG. 21 illustrates a CAD diagram yet another embodiment of the current apparatus 2100. The apparatus 2100 allows a bar or cylindrical projection such as a weightlifting bar to be slid into sleeve 2107 and secured with locking mechanism 2108 or by the way of a hinge clamp that tightens around the bar. The apparatus has full range of motion due to 2107, 2101 and 2102 being connected by pins/bolts 2103 and 2106. Connection point 2103 can be a removable pin/bolt allowing 2101 and 2107 in its entirety to connect to various other apparatuses or points of connection such as but not limited to a trailer hitch attachment point for a vehicle, a wall mount, a sled mount, a weightlifting rack attachment, an attachment piece for the center of apparatus FIG. 19 or attachment piece for FIG. 20. apparatus, etc. Sleeve 2104 allows apparatus 2100 to be positioned on any vertical or horizontal post such as a post that holds standard weightlifting plates. This sleeve 2104 is tightened around the post by the use of a screw clamp 2105 (same as apparatus one FIG. 20 screw clamp) or by means of a hinge clamp positioned on top or bottom of the sleeve 2104 that circumferentially tightens around the bar or post.

What is claimed is:

1. An apparatus, comprising:
a receiver, wherein the receiver is substantially cylindrical on a first end and substantially circular on a second end; and
a handle including a lower portion, wherein the handle is substantially oblong;
wherein the lower portion and the second end are detachably attached to one another via one or more securing objects positioned in a first aperture disposed on the second end;
wherein the receiver is configured to be detachably attached to a substantially cylindrical element via the one or more securing objects positioned in a second aperture disposed on the first end.

2. The apparatus of claim 1, wherein the handle may move from around 0 degrees to around 90 degrees when attached to the receiver.

3. The apparatus of claim 1, wherein the handle is fixed between around 0 degrees to around 90 degrees via a plurality of second apertures on the second end.

4. The apparatus of claim 1, wherein the cylindrical element is one or more of: an elongated object, a bar, and exercise equipment.

5. The apparatus of claim 1, further comprising connections disposed on the first end, wherein the connections are configured to receive one or more: weights, straps and bands.

6. The apparatus of claim 5, wherein the one or more weights, straps and bands are configured to produce a counterforce to the handle.

7. The apparatus of claim 1, wherein the handle is substantially one or more of: circular, square, rectangular, triangular, and solid shape.

8. The apparatus of claim 1, wherein the one or more securing objects is at least one of: removable, non-removable, a screw clamp, a pin, a hinge clamp, a clip, and a collar.

9. The apparatus of claim 1, wherein the receiver is substantially one or more of: circular, square, rectangular, triangular, and trapezoidal.

10. The apparatus of claim 1, wherein the receiver and the handle are unitary.

11. An apparatus, comprising:
a receiver, wherein the receiver is substantially cylindrical on a first end and substantially circular on a second end; and
a handle including a lower portion, wherein the handle is substantially oblong;
wherein the lower portion and the second end are detachably attached to one another via one or more securing objects positioned in a first aperture disposed on a bottom portion of the second end;
wherein the receiver is configured to be detachably attached to a substantially cylindrical element via the one or more securing objects positioned in a second aperture disposed on an upper portion of the first end.

12. The apparatus of claim 11, wherein the handle may move from around 0 degrees to around 90 degrees when attached to the receiver.

13. The apparatus of claim 11, wherein the handle is fixed between around 0 degrees to around 90 degrees via a plurality of additional apertures on the second end, wherein the plurality of additional apertures is on an opposing end of the first aperture.

14. The apparatus of claim 11, wherein the cylindrical element is one or more of: an elongated object, a bar, and exercise equipment.

15. The apparatus of claim 11, further comprising connections disposed on the first end, wherein the connections are:
configured to receive one or more: weights, straps and bands; and
are disposed around the first end.

16. The apparatus of claim 15, wherein the one or more weights, straps and bands are configured to produce a counterforce to the handle.

17. The apparatus of claim 11, wherein the handle is substantially one or more of: circular, square, rectangular, triangular, and solid shape.

18. The apparatus of claim 11, wherein the one or more securing objects is at least one of: removable, non-removable, a screw clamp, a pin, a hinge clamp, a clip, and a collar.

19. The apparatus of claim 11, wherein the receiver is substantially one or more of: circular, square, rectangular, triangular, and trapezoidal.

20. The apparatus of claim 11, wherein the receiver and the handle are unitary.

21. An apparatus, comprising:
a central portion;
an end portion located on each end of the central portion; and
a substantially circular handle disposed within each of the substantially semicircular portions;
wherein the handles are at opposing angles to one another;
wherein the central portion includes at least one eyelet configured to receive one or more elements.

22. The apparatus of claim 21, wherein the one or more elements include at least one of: a pad, a band, a rope, a rod, a bendable object, a rigid object, and another apparatus.

23. The apparatus of claim 21, wherein the one or more elements are configured to apply at least one of:
resistance; and
force.

24. The apparatus of claim 21, wherein the handles are at least one of:
rigid; and
rotatable.

25. The apparatus of claim 21, wherein the end portion is at least one of:
a substantially semicircular portion; and
a substantially circular portion.

26. The apparatus of claim 21, wherein the end portion is a circular casing containing:
a handle; and
ball-bearing system;
wherein the handle is configured to rotate.
